(19) United States
(12) Patent Application Publication
(10) Pub. No.: US 2025/0055673 A1
(43) Pub. Date: Feb. 13, 2025

(54) ELECTRONIC DEVICE FOR DIAGNOSING PASSWORD AND METHODS THEREOF

(71) Applicant: CRYPTO LAB INC., Seoul (KR)

(72) Inventors: Damien Stehle, Seoul (KR); Jung Hee Cheon, Seoul (KR); Jeongdae Hong, Seoul (KR)

(21) Appl. No.: 18/736,933

(22) Filed: Jun. 7, 2024

(30) Foreign Application Priority Data
Jun. 9, 2023 (KR) 10-2023-0074457
Jun. 15, 2023 (KR) 10-2023-0077113
May 28, 2024 (KR) 10-2024-0069608

(51) Int. Cl. H04L 9/00; H04L 9/08

(52) U.S. Cl. CPC H04L 9/008; H04L 9/0861

(57) ABSTRACT

Disclosed is an electronic device. The device includes: a communicator; a memory for storing information on a plurality of references for diagnosing a password; and a processor, wherein the processor is configured to acquire a calculation result in an encrypted form by performing a calculation based on a calculation key for each of a homomorphic ciphertext and the plurality of references, and transmit the calculation result to at least one external device through the communicator, in case of receiving the homomorphic ciphertext, in which the password is homomorphically encrypted, and data for the calculation key from the at least one external device through the communicator. Accordingly, the device can effectively diagnose whether the password is usable.

### TECHNICAL FIELD

The present disclosure relates to an electronic device for diagnosing a password and method thereof.

### BACKGROUND ART

As an information technology (IT) system expands, use of a password is also increasing. A user may set the password on a user device or data to prevent a third party from using the user device or data without consent. However, a type of password to set may often depend on the user's individual choice, and some users may thus set the password by referring to various anniversaries or meaningful numbers to make it easier to remember the password. This type of password is very vulnerable to hacking. Therefore, some organizations or companies set a strict standard for setting the password and restrict the setting and use of a password that does not meet the standard.

However, according to a conventional method, it may be difficult for the user to easily determine whether the password the user wants to use meets the standard set by the corresponding organization or company. If the organization or company directly diagnoses whether the password meets its standard, the user is required to directly inform the organization or company of the user password. In this case, the password may be leaked during a process of delivering the password, and there is a very high possibility that the password is leaked due to intention or mistake by a manager who manages all passwords at the corresponding organization or company.

Therefore, there has been a need for technology that may accurately diagnose whether the password the user wants to use is usable while maintaining security.

### DISCLOSURE

### Technical Solution

The present disclosure provides an electronic device capable of diagnosing whether a password is usable while maintaining security, and methods thereof.

According to at least one embodiment of the present disclosure, provided is an electronic device including: a communicator; a memory for storing information on a plurality of references for diagnosing a password; and a processor, wherein the processor is configured to acquire a calculation result in an encrypted form by performing a calculation based on a calculation key for each of a homomorphic ciphertext and the plurality of references, and transmit the calculation result to at least one external device through the communicator, in case of receiving the homomorphic ciphertext, in which the password is homomorphically encrypted, and data for the calculation key from the at least one external device through the communicator.

The reference may include at least one of the password password that has been hacked before, the password already used by a user, the password that violates a pre-established password policy, or the password related to a user identity.

The processor may be configured to acquire the calculation result by performing a subtraction calculation of the homomorphic ciphertext for each of the plurality of references using the calculation key, and then multiplying all subtraction results.

The processor may be configured to generate each of a secret signature key and a signature verification key for an electronic signature and store these keys in the memory, generate electronic signature data by applying the secret signature key to the calculation result and the homomorphic ciphertext, and transmit the electronic signature data and the calculation result to the at least one external device through the communicator.

The memory may store a machine learning model trained to diagnose the password, and the processor may be configured to input the homomorphic ciphertext to the machine learning model and transmit an output value of the machine learning model to the at least one external device through the communicator.

According to another embodiment of the present disclosure, provided is an electronic device including: a communicator; a memory; and a processor, wherein the processor is configured to receive, through the communicator, an encrypted calculation result ctₒᵤᵣ, a homomorphic ciphertext ct of the password, a password pwd, electronic signature data σ for the homomorphic ciphertext and the calculation result, and a zero-knowledge proof (ZKP) π for the calculation result, verify the received data by using a signature verification key to store a hash function value for the password in the memory in case that use of the password is allowed based on a verification result, and transmit the verification result to at least one external device through the communicator, in case that the set password is calculated with each of a plurality of references in a homomorphically encrypted ciphertext state by at least one the external device, the calculation result is decrypted by the at least one external device, and the password is confirmed as usable.

According to still another embodiment of the present disclosure, provided is a method of diagnosing a password by an electronic device, the method including: receiving a homomorphic ciphertext, in which the password is homomorphically encrypted, and data for a calculation key from at least one external device; acquiring a calculation result in an encrypted form by performing a calculation based on a calculation key for each of the homomorphic ciphertext and a plurality of pre-stored references; and transmitting the calculation result to the at least one external device.

The reference may include at least one of the password that has been hacked before, the password already used by a user, the password that violates a pre-established password policy, or the password related to a user identity.

In the acquiring of the calculation result, the calculation result may be acquired by performing a subtraction calculation of the homomorphic ciphertext for each of the plurality of references using the calculation key, and then multiplying all subtraction results.

The method may further include: generating each of a secret signature key and a signature verification key for an electronic signature and storing these keys; generating electronic signature data by applying the secret signature key to the calculation result and the homomorphic ciphertext; and transmitting the electronic signature data and the calculation result to the at least one external device.

The method may further include: acquiring an output value of a machine learning model by inputting the homomorphic ciphertext to the machine learning model trained to diagnose the password; and transmitting the output value to the at least one external device.

According to the various embodiments of the present disclosure as described above, the electronic device may minimize the password leakage possibility by diagnosing the password in the homomorphically encrypted state.

### DESCRIPTION OF DRAWINGS

FIG. 1 is a diagram showing a configuration of a network system according to at least one embodiment of the present disclosure;

FIG. 2 is a diagram for explaining an operation of each device included in the network system of FIG. 1;

FIG. 3 is a block diagram showing a configuration of a terminal device according to at least one embodiment of the present disclosure;

FIG. 4 is a block diagram showing a configuration of an electronic device according to at least one embodiment of the present disclosure;

FIG. 5 is a block diagram showing a configuration of a server device according to at least one embodiment of the present disclosure; and

FIG. 6 is a flow chart for explaining a method of diagnosing a password according to at least one embodiment of the present disclosure.

### BEST MODE

Encryption/decryption may be applied as necessary to a process of transmitting data (or information) that is performed in the present disclosure, and an expression describing the process of transmitting the data (or information) in the present disclosure and the claims should be interpreted as including all encryption/decryption cases even if not separately mentioned. In the present disclosure, an expression such as “transmission/transfer from A to B” or “reception from A to B” may include transmission/transfer or reception while having another medium included in the middle, and may not necessarily express only the direct transmission/transfer or reception from A to B.

In describing the present disclosure, a sequence of each operation should be understood as non-restrictive unless a preceding operation in the sequence of each operation needs to logically and temporally precede a subsequent operation. That is, except for the above exceptional case, the essence of the present disclosure is not affected even though a process described as the subsequent operation is performed before a process described as the preceding operation, and the scope of the present disclosure should also be defined regardless of the sequence of the operations. In addition, in the specification, “A or B” may be defined to indicate not only selectively indicating either one of A and B, but also including both A and B. In addition, a term “including” in the present disclosure may have a meaning encompassing further including other components in addition to components listed as being included.

The present disclosure only describes essential components necessary for describing the present disclosure, and does not mention components unrelated to the essence of the present disclosure. In addition, it should not be interpreted as an exclusive meaning that the present disclosure includes only the mentioned components, but should be interpreted as a non-exclusive meaning that the present disclosure may include other components as well.

In addition, in the present disclosure, a “value” may be defined as a concept that includes a vector as well as a scalar value.

Mathematical operations and calculations of each step in the present disclosure described below may be implemented as computer operations by a known coding method and/or coding designed to be suitable for the present disclosure to perform the corresponding operations or calculations.

Specific equations described below are exemplarily described among possible alternatives, and the scope of the present disclosure should not be construed as being limited to the equations mentioned in the present disclosure.

For convenience of explanation, the present disclosure defines the following notations.
a←D: Select an element a based on distribution D.
s1, s2∈R: Each of S1 and S2 is an element belonging to a set R.
mod(q): Perform modular calculation with an element q.
[⋅]: Round an internal value.

Hereinafter, various embodiments of the present disclosure are described in detail with reference to the accompanying drawings.

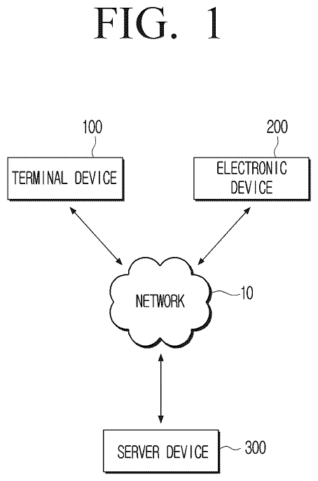

FIG. 1 is a diagram showing a configuration of a network system according to at least one embodiment of the present disclosure. According to FIG. 1, a terminal device 100, an electronic device 200, and a server device 300 may be connected to one another through a network 10.

The network 10 may be implemented as various types of wired and wireless communication networks, broadcasting communication networks, optical communication networks, cloud networks, and the like. FIG. 1 shows that the respective devices 100, 200, and 300 are indirectly connected to one another through the network 10, the devices are not limited thereto, and the respective devices 100, 200, and 300 may be connected to one another through wireless fidelity (WiFi), Bluetooth, near field communication (NFC), or the like without any separate medium.

In FIG. 1, the terminal device 100 may be an electronic device used by a user. In detail, the terminal device 100 may be implemented in various forms such as a personal computer (PC), a laptop PC, a mobile phone, a tablet PC, a kiosk, a game player, a television (TV), a home server, and an electronic device equipped with an internet of things (IoT) function.

The electronic device 200 may be a device for diagnosing a password set using the terminal device 100. The electronic device 200 may be implemented as a server device, or may be implemented as various devices such as the PC, the laptop PC, the mobile phone, the tablet PC, and the kiosk.

The server device 300 may verify a diagnosis result of the electronic device 200. FIG. 1 shows a case where the server device 300 and the electronic device 200 are implemented as separate devices. However, these devices are not necessarily limited thereto, and may be implemented as one device.

The user may directly input the password the user wants to use through the terminal device 100, and then receive the diagnosis from the electronic device 200. The user may receive the verification by transmitting the diagnosis result to the server device 300. In case of receiving proper verification, the user may use the password set by the user.

In detail, the terminal device 100 may set the password to allow use of the terminal device 100, set the password to allow use of an application or specific function, installed on the terminal device 100, or display a screen for setting various passwords such as a password for logging in to a specific homepage. The user may set the password to be used by the user by using various means, such as a button disposed on the terminal device 100, a soft keyboard displayed on the terminal device 100, or a remote control to control the terminal device 100.

In case that the password is set, the terminal device 100 may generate a key to be applied to the password. In detail, the terminal device 100 may generate each of a secret key and a public key. In the present disclosure, the secret key and the public key may be collectively referred to as the key or an encryption key.

The terminal device 100 may homomorphically encrypt the password set by the user by using the generated public key. In the present disclosure, a homomorphically encrypted password is referred to as a homomorphic ciphertext. In case of acquiring the homomorphic ciphertext, the terminal device 100 may transmit the homomorphic ciphertext and data such as the public key to the electronic device 200 through the network 10.

In case of receiving these data, the electronic device 200 may acquire a calculation result compared to a pre-stored reference and then transmit the same to the terminal device 100. The password in a form of the homomorphic ciphertext may be provided to the electronic device 200, and the electronic device 200 may thus perform a calculation without decrypting the homomorphic ciphertext. Accordingly, the user may secure the calculation result without exposing the password set by the user to the external electronic device 200 or the like. The calculation may be a comparison calculation that compares the reference with the homomorphic ciphertext.

The electronic device 200 is unable to directly check the calculation result in a homomorphic ciphertext state, and the electronic device 200 may thus transmit the calculation result to the terminal device 100. The terminal device 100 may decrypt the calculation result by using the secret key. The terminal device 100 may determine that the password set by the user is an unusable password in case that as a decryption result, the calculation result meets a disallowance condition (for example, in case that a calculation value is 0). In this case, the terminal device 100 may provide a message to input a new password.

On the other hand, the terminal device 100 may determine that the password set by the user is usable in case that the calculation result meets an allowance condition (for example, in case that the calculation value is not 0). Accordingly, the terminal device 100 may output a message indicating that the password set by the user may be usable.

Meanwhile, the system may be designed to use the password after the diagnosis is verified by a separate device even in case that the password is diagnosed by the electronic device 200. In the case of FIG. 1, the terminal device 100 may decrypt the calculation result and then transmit, to the server device 300, data for an encrypted calculation result ctₒᵤₜ, the password, the homomorphic ciphertext, or the like in case that the password is usable. In case that the electronic device 200 provides electronic signature data for the calculation result, the terminal device 100 may further transmit the electronic signature data, zero-knowledge proof (ZKP) for the password, or the like.

In case of receiving these data, the server device 300 may verify the data by using a signature verification key used to generate the electronic signature data. The server device 300 may transmit a verification result to the terminal device 100. For example, in case that the verification is successful, the server device 300 may transmit a message indicating allowance to use the password to the terminal device 100. On the other hand, in case that the verification fails, the server device 300 may request data retransmission or transmit a message indicating disallowance to use the password to the terminal device 100.

The network system shown in FIG. 1 may be used in various environments. For example, the electronic device 200 may be implemented as a server device operated by an organization such as the National Intelligence Service, the Financial Supervisory Service, a security specialized agency, or a government agency. The server device 300 may be implemented as a server device operated by an organization that wants to use the password having high security, such as various companies, banks, military units, and researchers.

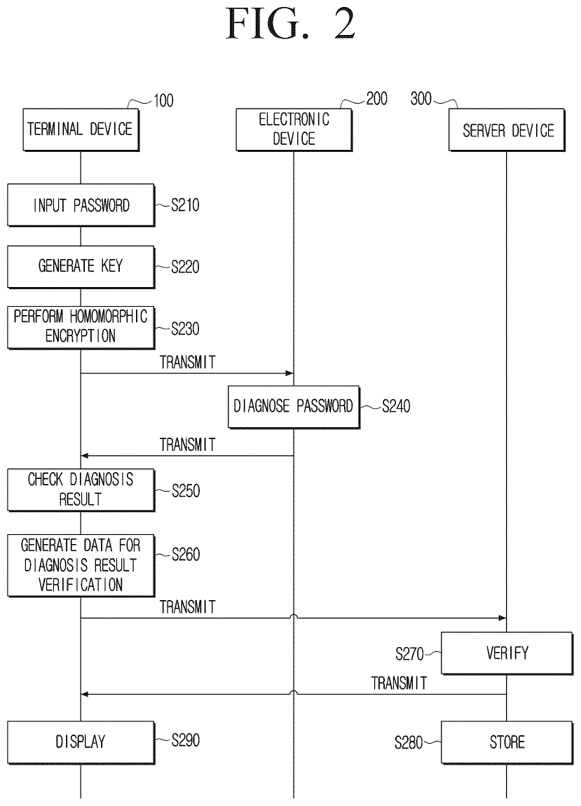

FIG. 2 is a timing chart for explaining operations of devices according to at least one embodiment of the present disclosure. FIG. 2 shows a case where one terminal device 100, one electronic device 200, and one server device 300 are respectively provided, and the numbers of the respective devices may be changed. For example, many users may receive the diagnosis by using the electronic device 200 after setting the password by using the terminal devices of the users.

Referring to FIG. 2, the user may input the password the user wants to use by using the terminal device 100 (S210). For example, the terminal device 100 may display a password setting screen in case that the user wants to input the password to access a system operated by the server device 300. The terminal device 100 may generate a key for homomorphically encrypting the password in case that the user inputs the password through the password setting screen (S220). The key may include the public key, the secret key, a calculation key, or the like.

A key generation method is described in more detail again in a section below.

In addition, the terminal device 100 may generate various calculation keys used for calculation (evaluation or computation) for the homomorphic ciphertext. In detail, the calculation key may include a relinearization key rlk, a rotation key rotKey, or the like. The relinearization key may be used for multiplication calculation, and the rotation key may be used for rotation calculation.

In case of generating the public key and the secret key, the terminal device 100 may homomorphically encrypt the password by using the generated public key (S230). The terminal device 100 may include, in the homomorphic ciphertext, encryption noise, that is, the above-described error produced in a process of performing the homomorphic encryption. In detail, the homomorphic ciphertext generated by the terminal device 100 may be generated in a way that a result value including the password and an error value is restored in case that the decryption is performed later by using the secret key.

The terminal device 100 may store the generated homomorphic ciphertext, and then transmit the homomorphic ciphertext and the calculation key together to the electronic device 200.

The electronic device 200 may diagnose the password by performing the calculation based on the calculation key for each of the homomorphic ciphertext and the plurality of pre-stored references in case that the electronic device 200 receives the data for the homomorphic ciphertext and the calculation key (S240).

The reference may be reference data set for diagnosing the password. In detail, the reference may include at least one of various references such as the password that has been hacked before, the password already used by the user, the password that violates a pre-established password policy, and the password related to a user identity.

The electronic device 200 may perform the calculation in the homomorphically encrypted state, and thus acquire the calculation result in an encrypted form. In case of acquiring the calculation result in the encrypted form, the electronic device 200 may transmit the calculation result to the terminal device 100.

In this case, the electronic device 200 may perform an electronic signature to confirm that the diagnosis on the calculation result is made properly, and transmit the electronic signature data and the calculation result together to the terminal device 100.

The terminal device 100 may decrypt the transmitted calculation result and check the diagnosis result (S250). The terminal device 100 may determine that the password is usable in case that the decrypted diagnosis result has a predetermined value (for example, 1), and determine that the password is unusable in case that the decrypted diagnosis result has a value (for example, 0) different from the predetermined value. As in the example described above, a password A12kim may be different from the reference in case that a password such as ABCD, 1234, or 5678 is stored as the reference, and the diagnosis result may thus have a value other than 0, and as a result, the terminal device 100 may determine that the password A12kim is usable.

As in another example, the predetermined value may be set to 0 in case that the reference is stored according to a policy that the password is required to necessarily include at least one special symbol. In this case, if the password includes the special symbol, a comparison calculation result may be 0, which is the same as the predetermined value, and the terminal device 100 may thus determine that the password is usable. On the other hand, the password A12kim described above includes no special symbol, and the calculation result with the reference to the special symbol may thus have the value other than 0. Therefore, the calculation result may have the value different from the predetermined value, and the terminal device 100 may thus determine that A12kim is unusable.

As described above, the reference may be variously changed based on an embodiment.

The terminal device 100 may generate data for diagnosis result verification in case of determining that the password is usable as the diagnosis result (S260), and may then transmit the same to the server device 300.

The data for the verification may be configured in various ways. As an example, the terminal device 100 may transmit the data including the encrypted calculation result, the password, the homomorphic ciphertext, the electronic signature data, zero-knowledge proof for the password, or the like. A zero-knowledge proof may be performed between the terminal device 100 and the server device 300. The zero-knowledge proof is encryption technology for a prover to prove a user statement to a verifier. According to the various embodiments of the present disclosure, the terminal device 100 may serve as the prover, and the server device 300 may serve as the verifier. The zero-knowledge proof may include an interactive zero-knowledge proof (IZP) and the non-interactive zero-knowledge proof (NIZKP).

The zero-knowledge proof in the various embodiments of the present disclosure may be the non-interactive zero-knowledge proof (NIZKP), and is not limited thereto.

For the zero-knowledge proof, the terminal device 100 may generate a proving key and a verification key. The terminal device 100 may transmit the generated verification key to the server device 300 and share the same with the server device 300. The terminal device 100 may generate the zero-knowledge proof by encrypting the data including the proving key, the statement to be proven, the password, or the like. Here, the statement may be the diagnosis result received from the terminal device 100.

The server device 300 may verify the received data in case of receiving the data (S270). In detail, the server device 300 may check whether a result value of a function calculation is true or false by using the received data as an input value of a verification function. According to this method, the server device 300 may perform the verification without knowing the password, which is only known to the terminal device 100. If the result is true, the server device 300 may confirm that the statement of the terminal device 100 is correct.

The server device 300 may transmit the verification result to the terminal device 100, or transmit the data as a result of determining whether to allow the password based on the verification result. The server device 300 may store the verification result or the resulting data on its own (S280). In this case, the server device 300 may store a hash function value for the password. The server device 300 may prevent password duplication with another user based on the stored value.

Hereinabove, the description describes a general process of a zero-knowledge proof protocol. Specific methods of the zero-knowledge proof are disclosed in Korea Patent Nos. 10-2599406, 10-2257779, and the like. Therefore, the description omits their detailed descriptions.

The terminal device 100 may check whether the password is allowed based on the data, and display a check result in case of receiving the verification result or the resulting data (S290). For example, the terminal device 100 may display the message indicating the disallowance to use the password in case of determining that the password input by the user does not meet the reference. The user may repeat the step described above by inputting the new password again. The terminal device 100 may restrict the password input itself in case that the new password is disallowed a predetermined number of times (for example, 5 times) or more. On the other hand, the terminal device 100 may display the message indicating the allowance to use the password, or switch the password setting screen to a next screen in case that the password meets the reference and its verification is completed.

FIGS. 1 and 2 show a method of diagnosing the password in a state where the terminal device 100, the electronic device 200, and the server device 300 are connected to one another through the communication. However, the devices do not necessarily have to be implemented in this way. The electronic device 200 and the server device 300 may be implemented as one device. In addition, the method may be implemented to determine whether to use the password by omitting a verification process. Hereinafter, the description describes the configuration and operation of each device in detail.

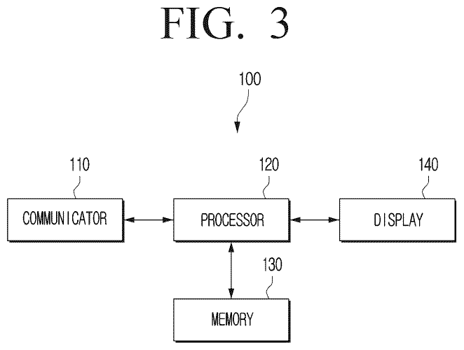

FIG. 3 is a block diagram showing a configuration of a terminal device 100 according to at least one embodiment of the present disclosure. As described above, the terminal device 100 may be implemented as the various types of electronic devices, and may further include various configurations based on the type. However, FIG. 3 mainly shows components necessary to describe the embodiments of the present disclosure.

Referring to FIG. 3, the terminal device 100 may include a communicator 110, a processor 120, a memory 130, and a display 140. The terminal device 100 in FIG. 3 may alternatively be described in various ways, such as a user device, a user terminal device, and a personal device, and may also be described as an electronic device, which collectively refers to these devices.

The communicator 110 may communicate with an external device. In the case of FIG. 1, the external device may be the electronic device 200, the server device 300, or the like, is not limited thereto, and may communicate with various types of devices.

The communicator 110 may transmit and receive various signals and data to the external device by using various wired and wireless communication methods such as a wired/wireless local area network (LAN), a wide area network (WAN), Ethernet, an IEEE 1394, a Bluetooth, an access point (AP) based wireless fidelity (WiFi, i.e., wireless local area network (LAN)), a Zigbee, a high definition multimedia interface (HDMI), a universal serial bus (USB), a mobile high-definition link (MHL), an audio engineering society/European broadcasting union (AES/EBU) communication, an optical communication, and a coaxial communication.

The memory 130 may store various programs, data, and instructions necessary for operating the terminal device 100. The memory 130 may be implemented as at least one of various memories such as a dynamic random access memory (DRAM), a static RAM (SRAM), a synchronous dynamic RAM (SDRAM), an one time programmable read only memory (OTPROM), a programmable ROM (PROM), an erasable and programmable ROM (EPROM), an electrically erasable and programmable ROM (EEPROM), a mask ROM, a flash ROM, a flash memory, a hard drive, and a solid state drive (SSD).

The display 140 may display various screens. The various sizes, types, and shapes of the display 140 may depend on the types of the terminal device 100. In detail, the display 140 may be implemented as various types of displays such as a liquid crystal display (LCD), an organic light emitting diode (OLED) display, a light emitting diode (LED) display, a micro light emitting diode (micro LED) display, a mini LED display, a plasma display panel (PDP), a quantum dot (QD) display, and a quantum dot light-emitting diode (QLED) display. The display 140 may be implemented as a touch screen, and is not necessarily limited thereto.

The processor 120 may control overall operations of the terminal device 100. The processor 120 may perform various operations based on the instructions, programs, and the data, stored in the memory 130.

For example, in case that the user selects an internet browser, the processor 120 may execute a browser program stored in the memory 130, and then control the display 140 to display an execution screen. In case that the user inputs a specific uniform resource locator (URL) or accesses a specific server device (for example, the server device 300 in FIG. 1) through a link, the processor 120 may control the display 140 to display a web page provided by the server device 300.

The user may need to set the password depending on a security policy of the server device 300. In principle, the password may be set arbitrarily by the user. However, only the password that meets the reference may be usable in case that the server device 300 establishes a policy regarding the password reference. The password reference is required to be managed regularly and strictly to minimize a possibility of hacking. However, such management may be difficult in case that the server device 300 is a device operated by an organization or group having weak security expertise. Accordingly, in the various embodiments of the present disclosure, the allowance to use the password may be implemented in case that the diagnosis is received from the external electronic device 200 having the security expertise.

In case that the password setting is attempted, the processor 120 may generate a key for the homomorphic encryption, and use the key to homomorphically encrypt the password input by the user to thus generate the homomorphic ciphertext.

As an example, the processor 120 may generate the public key by using a Ring-LWE technique. In detail, the processor 120 may first set various parameters and rings, and store the same in the memory 130. Examples of the parameters may include a length of a plaintext message bit, a size of the public key, a size of the secret key, and the like.

The ring may be expressed as the following equation.

$$R = {Z}_{q} [ X ] / f ( x ) \qquad [ Equation 1 ]$$

Here, R indicates the ring, Z_{q} indicates a coefficient, and f(x) indicates an N-th polynomial.

The ring indicates a set of polynomials having predetermined coefficients, and indicates the set in which addition and multiplication are defined between elements and are closed for the addition and the multiplication.

As an example, the ring R indicates a set of the N-th polynomials whose coefficient is Z_{q}. In detail, when n is (D(N), the polynomial indicates a polynomial which may be calculated as the remainder of dividing the polynomial by an N-th cyclotomic polynomial.

In Equation 1, f(x) indicates ideal of Z_{q}[x] generated by f(x). The Euler totient function Φ(N) indicates the number of natural numbers that are prime to N and smaller than N. If Φ_{N}(X) is defined as the n-th cyclotomic polynomial, the ring may also be expressed in Equation 2 as follows.

$$R = {Z}_{q} [ X ] / {Φ}_{N} ( x ) \qquad [ Equation 2 ]$$

Meanwhile, the ring R in Equation 2 described above may have binary data in a plain text space. In case that the ring is set, the processor 120 may calculate a secret key sk from the ring. The secret key sk may be expressed as follows.

$$sk ← ( 1 , s ( x ) ) , s ( x ) ∈ R \qquad [ Equation 3 ]$$

Here, s(x) indicates a random polynomial generated using a small coefficient.

In addition, the processor 120 may calculate a first random polynomial a(x) from the ring. The first random polynomial may be expressed as follows.

$$a ( x ) ← R \qquad [ Equation 4 ]$$

In addition, the processor 120 may calculate the error. In detail, the processor 120 may extract the error from a discrete Gaussian distribution or a distribution having a statistical distance close thereto. This error may be expressed as follows.

$$e ( x ) ← {D}_{α q}^{n} \qquad [ Equation 5 ]$$

In case that even the error is calculated, the processor 120 may calculate a second random polynomial by performing modular calculations on the error in the first random polynomial and the secret key. The second random polynomial may be expressed as follows.

$$b ( x ) = - a ( x ) s ( x ) + e ( x ) ( mod q ) \qquad [ Equation 6 ]$$

Finally, a public key pk may be set to include the first random polynomial and the second random polynomial as follows.

$$pk = ( b ( x ) , a ( x ) ) \qquad [ Equation 7 ]$$

The key generation method described above is only an example, and is not necessarily limited thereto, and the processor 120 may generate various keys in other ways.

Meanwhile, the homomorphic ciphertext generated by the processor 120 may satisfy the following property in case of performing the decryption later by using the secret key.

$$Dec ( ct , sk ) = < ct , sk >= M + e ( mod q ) \qquad [ Equation 8 ]$$

Here, < and > indicate dot product calculation (or usual inner product), ct indicates the ciphertext, sk indicates the secret key, e indicates an encryption error value, and mod q indicates a modulus of the ciphertext. M indicates a plaintext message, and may be the password in the various embodiments of the present disclosure.

q needs to be chosen larger than the result value M multiplied by a scaling factor Δ to the message. In case that an absolute value of the error value e is sufficiently smaller than M, a decryption value M+e of the ciphertext may be a value that may replace an original message by the same precision in significant figure calculation. Among decrypted data, the error may be disposed on the least significant bit (LSB) side, and M may be disposed on the next least significant bit side.

In case that a size of the message is too small or too large, the processor 120 may adjust the size by using the scaling factor. In case that the scaling factor is used, not only a message in an integer form but also a message in a real number form may be encrypted, and its usability may thus be greatly increased. In addition, the size of the message may be adjusted using the scaling factor to thus also adjust a size of an effective region, that is, a region where the messages exist in the ciphertext after the calculation is performed.

In some embodiments, the modulus q of the ciphertext may be set and used in various forms. For example, the modulus of the ciphertext may be set in the form of an exponential power q=Δ^{L} of the scaling factor Δ. In case that Δ is 2, the modulus may be set to a value such as q=2¹⁰.

In addition, the homomorphic ciphertext according to the present disclosure is described assuming that a fixed point is used. However, the homomorphic ciphertext may also be applied even in case that a floating point is used.

The processor 120 may store data for the keys generated for the homomorphic encryption and the homomorphic ciphertext in the memory 130.

The processor 120 may transmit the data for the generated homomorphic ciphertext, calculation key, or the like to the external device, that is, the electronic device 200, through the communicator 110. The processor 120 may then decrypt the calculation result by using the secret key among the keys stored in the memory 130 in case of receiving the calculation result through the communicator 110.

The processor 120 may generate the zero-knowledge proof based on the decrypted calculation result. The processor 120 may transmit a homomorphic ciphertext ct, the calculation result ctₒᵤₜ, a password pwd, an electronic signature data σ for the homomorphic ciphertext and the calculation result, and zero-knowledge proof (ZKP) 71 for the calculation result to the server device 300 through the communicator 110. The zero-knowledge proof π is data that proves the fact that Dec(ct)=pwd, Dec(ctₒᵤₜ)=1.

As described above, the server device 300 may perform the verification on the received data. The verification may be performed in two steps. In detail, the server device 300 may check whether Verify_{swk}(pwd ∥ct∥ctₒᵤₜ, σ)=1, and verify the zero-knowledge proof π.

The server device 300 may determine that the verification is successful in case that the fact that Dec(ct)=pwd and Dec(ctₒᵤₜ)=1 is proved to be true by the zero-knowledge proof π. The server device 300 may transmit the verification result to the terminal device 100.

The processor 120 may generate the message indicating the allowance/disallowance to use the password based on the verification result in case of receiving the verification result from the server device 300 through the communicator 110. The processor 120 may control the display 140 to display the generated message. If verification fails, the processor 120 may generate the message indicating the disallowance to use the password. The processor 120 may count the number of verification failures, and store the same in the memory 130. The processor 120 may block further attempts to set the password in case that the counted number of times meets the predetermined number of times.

The example above describes the case of accessing the web page provided by the server device 300 and setting the password as a reference, the present disclosure is not necessarily limited thereto, and the processor 120 may also perform the above-described operation during a password setting process used in various fields.

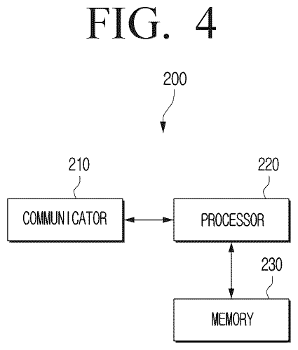

FIG. 4 is a block diagram showing a configuration of the electronic device according to at least one embodiment of the present disclosure. In detail, the electronic device in FIG. 4 may be the electronic device 200 used in the system of FIG. 1, is not necessarily limited thereto, and may be the electronic device 200 equipped with the function of the server device 300 or another function. The electronic device 200 in FIG. 4 may alternatively be described in various ways, such as a diagnostic device, a server device, a management device, a security device, and the like.

Referring to FIG. 4, the electronic device 200 may include a communicator 210, a processor 220, and a memory 230. A specific example of each of the communicator 210, the processor 220, and the memory 230 is not significantly different from the configuration in FIG. 3, and the description thus omits its redundant description.

The communicator 210 may communicate with at least one external device. As described with reference to FIGS. 1 to 3, the communicator 210 may receive the corresponding data in case that the terminal device 100 transmits the homomorphic ciphertext and the calculation key.

The processor 220 may store the data received through the communicator 210 in the memory 230. The processor 220 may perform the diagnosis on the homomorphic ciphertext among the stored data.

The memory 230 may store various programs, data, and instructions necessary for operating the electronic device 200. In detail, the memory 230 may store data for a reference for the diagnosis. In the present disclosure, the reference may include various data that serve as the basis for determining whether the password is usable, such as a password example unsuitable for the use, a predetermined reference or policy for the allowance/disallowance to use the password, or a password example unsuitable according to the reference or policy.

The password example unsuitable for the use may include the password that has been hacked before, the password already used by the user, the password related to the user identity (e.g., name, date of birth, or wedding anniversary), a password (e.g., 0000, aaaa, or !!!!) having the same numbers, letters, or symbols repeated by a certain number of times or more, a password (e.g., 1234 or abcd) having a certain number or more of numbers or letters listed sequentially, or the like.

The pre-established password policy may include various policies such as requiring mixed use of uppercase and lowercase English letters, use of at least one of numbers and symbols, use of at least 6 characters, and use of a password that includes at least 3 characters different from those in the previously used password.

The processor 220 may perform the password diagnosis based on this reference. In detail, the processor 220 may perform the calculation based on the calculation key for each of the received homomorphic ciphertext and plurality of references in case of receiving the homomorphic ciphertext, in which the password is homomorphically encrypted, and the data for the calculation key from at least one external device (e.g., terminal device 100) through the communicator 210. The processor 220 may perform the calculation in the homomorphically encrypted state, and thus also acquire the calculation result in the encrypted form. The processor 220 may transmit the calculation result in the encrypted form to at least one external device through the communicator 210.

For example, in case that the password such as ABCD, 1234, or 5678 is the password password that has been hacked before, a memory 230 may store a list of the plurality of references where each of these passwords is registered as the reference.

In case of receiving the homomorphic ciphertext, the processor 220 may acquire a final calculation result by performing the calculation that compares each reference with the homomorphic ciphertext, and then collecting the comparison calculation results. The processor 220 may perform a subtraction calculation as an example of the comparison calculation. That is, the processor 220 may perform the subtraction calculation of the homomorphic ciphertext for each reference one by one, and then multiply all the respective subtraction results.

The processor 220 may perform the multiplication by using the calculation key transmitted from the terminal device 100. If the password set by the user is 1234, this password may the same as one of the pre-stored references in the memory 230. Therefore, a value acquired from the subtraction calculation with the reference may be 0. Therefore, even if a value acquired from the subtraction calculation with the remaining reference is not 0, the final calculation result may be 0 in case that the final multiplication is performed.

Meanwhile, as described above, the predetermined password policy may also be used as the reference. The password policy may be a reference to distinguish the usable password and the unusable password from each other. For example, a policy requiring the password to include at least one of various items such as uppercase English letters, numbers, and symbols, to be set to include at least 6 characters, or not to include 3 consecutive numbers or more may be pre-established. In this case, the reference may include data in which the numbers from 0 to 9 are homomorphically encrypted, data in which the various symbols are homomorphically encrypted, data in which uppercase English letters are homomorphically encrypted, and the like.

The processor 120 of the terminal device 100 may segment the password set by the user into predetermined units and then perform the homomorphic encryption thereon. For example, if the password is set to A12kim, the terminal device 100 may homomorphically encrypt A, 1, 2, k, i, and m, respectively. However, the present disclosure is not limited thereto. The terminal device 100 may encrypt the entire password as is and transmit the homomorphic ciphertext, and the processor 220 of the electronic device 200 may segment the homomorphic ciphertext into the predetermined units and compare the same with the reference.

In detail, the memory 230 of the electronic device 200 may include, as the reference, various uppercase and lowercase letters, numbers 0 to 9, various symbols such as +, −, #, ?, and !, and data for a sequence in which these characters are arranged sequentially.

The processor 220 of the electronic device 200 may compare each of the plurality of homomorphic ciphertexts with the reference in case of receiving the plurality of homomorphic ciphertexts for each unit character included in the entire password or a string included of the unit character. The processor 220 may segment the homomorphic ciphertext into a plurality of segments and compare the same with the reference in case of receiving the entire homomorphic ciphertext corresponding to the entire password as is.

Assume that the password A12kim is input in a state where the policy that the password is required to include at least one special symbol is established. In this case, the processor 220 may sequentially perform the subtraction calculation and the multiplication calculation for each reference as described above. The subtraction calculation result for “A” and the calculation result for “1” and “2” may all be 0 in case that the references to the uppercase letters and the numbers are stored. On the other hand, the received password A12kim includes no special symbol, and the calculation result with the reference to the special symbol may thus have the value other than 0.

As described above, the calculation result may include the data that reflects its relevance to the reference. The processor 220 may frequently update the reference stored in the memory 230. For example, the processor 220 may add the new password to the reference in case of receiving a hacking history of the new password through the communicator 210. In addition, the processor 220 may update the reference according to the received policy case of receiving the new password policy from the server device 300 and another device.

The processor 220 may transmit the calculation result to the terminal device 100 through the communicator 210.

Meanwhile, the processor 220 may also perform the transmission by adding the electronic signature for the calculation result. To this end, the processor 220 may generate a secret signature key and a signature verification key for the electronic signature, and then store these keys in the memory 230. The processor 220 may generate the electronic signature data a by applying the secret signature key to the homomorphic ciphertext ct and the calculation result ctₒᵤₜ, and then transmit the calculation result and the electronic signature data to the terminal device 100 through the communicator 210. The electronic signature data a may be expressed as σ=signₛₛₖ(ct∥ctₒᵤₜ). Here, ssk may be the secret signature key, and sign may be an electronic signature function.

The processor 220 may not only perform the above-described operation for one terminal device, but also perform the above-described operation in a relation with the plurality of various terminal devices. In this case, the memory 230 may store different references according to different security policies or security levels. For example, the memory 230 may provide the terminal device or the server device that requires a strong security level with the calculation result by performing various calculations on a number of different references, and provide the terminal device or the server device that requires a relatively weak security level with the calculation result by performing a relatively small number of calculations on one reference or a small number of references.

Meanwhile, the memory 230 may store a machine learning model trained to diagnose the password. In detail, the electronic device 200 may train the machine learning model by homomorphically encrypting reference passwords generated based on various references, and then inputting the ciphertexts and their labeling data into the machine learning model.

In case of receiving the homomorphic ciphertext, the processor 220 may input the received homomorphic ciphertext to the machine learning model and then acquire an output value. The processor 220 may transmit the output value as is or the output value and the electronic signature data for the output value together to the terminal device through the communicator 210.

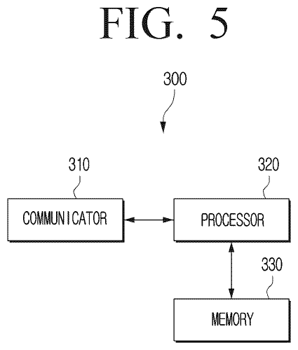

FIG. 5 is a block diagram showing a configuration of the server device according to at least one embodiment of the present disclosure. The server device 300 may alternatively be described in various ways, such as an electronic device, a verification device, an organization server, and a password management server.

Referring to FIG. 5, the server device 300 may include a communicator 310, a processor 320, and a memory 330. A specific example of each of the communicator 310, the processor 320, and the memory 330 is not significantly different from the configuration in FIG. 3, and the description thus omits its redundant description.

The communicator 310 may receive various data from the terminal device 100. As described above, the terminal device 100 may transmit various types of data that require the verification in case that the password set by the terminal device 100 is provided to the electronic device 200 in the homomorphically encrypted ciphertext state, calculated with each of the plurality of references by the electronic device 200, and then decrypted again by the terminal device 100. In detail, the communicator 310 may receive the data including the decrypted calculation result, the password, the homomorphic ciphertext, the electronic signature data, the zero-knowledge proof about the password, or the like.

The processor 320 may store the received data in the memory 330. In addition, the processor 320 may store the data in the memory 330 in case of receiving the data such as the signature verification key from the electronic device 200.

The processor 320 may verify the data transmitted from the terminal device 100 by using the signature verification key. The processor 320 may transmit the verification result or information on the determined allowance/disallowance to use the password based on the verification result to the terminal device 100 through the communicator 310 in case of determining the allowance/disallowance to use the password based on the verification result. Separately, the processor 320 may calculate the hash function value for the password whose verification is completed. The processor 320 may store the calculated hash function value in the memory 330. Accordingly, the processor 320 may manage to prevent another user from using the same password in the future. The processor 320 may provide the calculated hash function value to the electronic device 200. The electronic device 200 may update the reference based on the data in case of receiving the data.

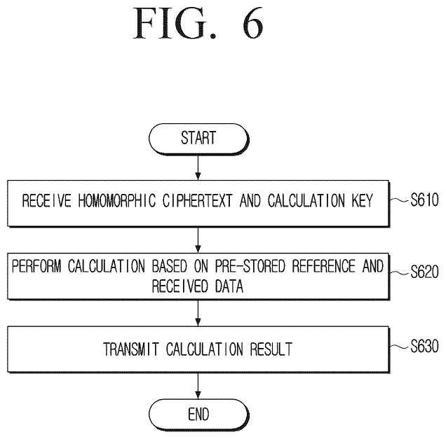

FIG. 6 is a flow chart for explaining a method of diagnosing a password by an electronic device according to at least one embodiment of the present disclosure. Referring to FIG. 6, an electronic device may receive data such as a homomorphic ciphertext and a calculation key from a terminal device (S610). The homomorphic ciphertext may be a ciphertext in which a password to be set is homomorphically encrypted, and the calculation key may be a key which may be used for a specific calculation on the homomorphic ciphertext.

The electronic device may perform the calculation based on the received data and a plurality of pre-stored references (S620). In detail, the electronic device may acquire a final calculation result by performing a comparison calculation that compares the received data with each of the plurality of references, and then collecting comparison calculation results. The comparison calculation may be performed by the subtraction calculation, and the final calculation result may be acquired by multiplying all the subtraction calculation values, and is not necessarily limited thereto.

The electronic device may transmit the calculation result back to the terminal device (S630). In this case, the electronic device may generate each of a secret signature key and a signature verification key for the electronic signature, then generate electronic signature data by applying the secret signature key to the calculation result and the homomorphic ciphertext, and also transmit the electronic signature data and the calculation result together to the terminal device.

Meanwhile, in case that a machine learning model is stored instead of the reference, the electronic device may acquire an output value of the machine learning model that uses the received homomorphic ciphertext as an input value, and then transmit the output value to the terminal device. In this case, the electronic device may also transmit the electronic signature data for the output value.

The method of diagnosing a password in FIG. 6 may be performed by the electronic device having the configuration shown in FIG. 4, is not necessarily limited thereto, and may also be performed by the electronic device having various configurations.

The contents in the various embodiments described above may be implemented independently for each embodiment, or may be implemented in combination with at least some of the other embodiments of the present disclosure.

In addition, the various embodiments described above may be implemented by software including an instruction stored in a machine-readable storage medium (for example, a computer-readable storage medium). A machine may be a device that invokes the stored instruction from the storage medium and may be operated based on the invoked instruction, and may include the server device according to the disclosed embodiments. In case that the instruction is executed by the processor, the processor may perform a function corresponding to the instruction directly or by using another component under control of the processor. The instruction may include a code provided or executed by a compiler or an interpreter. The machine-readable storage medium may be provided in the form of a non-transitory storage medium. Here, the term “non-transitory” indicates that the storage medium is tangible without including a signal, and does not distinguish whether data are semi-permanently or temporarily stored in the storage medium.

In addition, the methods according to the various embodiments described above may be included in a computer program product and then provided. The computer program product may be traded as a product between a seller and a purchaser. The computer program product may be distributed in a form of the machine-readable storage medium (for example, a compact disc read only memory (CD-ROM)) or online through an application store (for example, PlayStore™). In case of the online distribution, at least some of the computer program products may be at least temporarily stored in a storage medium such as a memory of a server of a manufacturer, a server of an application store, or a relay server, or be temporarily generated.

Each of the components (for example, modules or programs) according to the various embodiments described above may include a single entity or a plurality of entities, and some of the corresponding sub-components described above may be omitted or other sub-components may be further included. Alternatively or additionally, some of the components (e.g., modules or programs) may be integrated into one entity, and may perform functions performed by the respective corresponding components before being integrated in the same or similar manner. Operations performed by the modules, the programs or other components according to the various embodiments may be executed in a sequential manner, a parallel manner, an iterative manner or a heuristic manner, and at least some of the operations may be performed in a different order, may be omitted, or other operations may be added.

Although the embodiments are shown and described in the present disclosure as above, the present disclosure is not limited to the above-mentioned specific embodiments, and may be variously modified by those skilled in the art to which the present disclosure pertains without departing from the gist of the present disclosure as claimed in the accompanying claims. These modifications should also be understood to fall within the scope and spirit of the present disclosure.

1. An electronic device comprising:
a communicator;
a memory for storing information on a plurality of references for diagnosing a password; and
a processor,
wherein the processor is configured to:
based on receiving the homomorphic ciphertext, in which the password is homomorphically encrypted, and data for the calculation key from at least one external device through the communicator,
acquire a calculation result in an encrypted form by performing a calculation based on the calculation key for each of a homomorphic ciphertext and the plurality of references, and
transmit the calculation result to the at least one external device through the communicator.

2. The device as claimed in claim 1, wherein the reference includes at least one of the password that has been hacked before, the password already used by a user, the password that violates a pre-established password policy, or the password related to a user identity.

3. The device as claimed in claim 1, wherein the processor is configured to acquire the calculation result by performing the calculation that compares the homomorphic ciphertext with each of the plurality of references by using the calculation key, and then collecting comparison calculation results.

4. The device as claimed in claim 1, wherein the processor is configured to
generate each of a secret signature key and a signature verification key for an electronic signature and store these keys in the memory,
generate electronic signature data by applying the secret signature key to the calculation result and the homomorphic ciphertext, and
transmit the electronic signature data and the calculation result to the at least one external device through the communicator.

5. The device as claimed in claim 1, wherein the memory stores a machine learning model trained to diagnose the password, and
the processor is configured to input the homomorphic ciphertext to the machine learning model and transmit an output value of the machine learning model to the at least one external device through the communicator.

6. An electronic device comprising:
a communicator;
a memory; and
a processor,
wherein the processor is configured to
based on password set on at least one external device is calculated with each of a plurality of references in a homomorphically encrypted ciphertext state, the calculation result is decrypted by the at least one external device, and the password is confirmed as usable,
receive, through the communicator, an encrypted calculation result ctₒᵤₜ, a homomorphic ciphertext ct, a password pwd, electronic signature data σ for the homomorphic ciphertext and the calculation result, and a zero-knowledge proof (ZKP) π for the calculation result,
verify the received data by using a signature verification key to store a hash function value for the password in the memory in case that use of the password is allowed based on a verification result, and
transmit the verification result to at least one external device through the communicator.

7. A method of diagnosing a password by an electronic device, the method comprising:
receiving a homomorphic ciphertext, in which the password is homomorphically encrypted, and data for a calculation key from at least one external device;
acquiring a calculation result in an encrypted form by performing a calculation based on a calculation key for each of the homomorphic ciphertext and a plurality of pre-stored references; and
transmitting the calculation result to the at least one external device.

8. The method as claimed in claim 7, wherein the reference includes at least one of the password that has been hacked before, the password already used by a user, the password that violates a pre-established password policy, or the password related to a user identity.

9. The method as claimed in claim 7, wherein in the acquiring of the calculation result, the calculation result is acquired by performing the calculation that compares the homomorphic ciphertext with each of the plurality of references by using the calculation key, and then collecting comparison calculation results.

10. The method as claimed in claim 7, further comprising:
generating each of a secret signature key and a signature verification key for an electronic signature and storing these keys;
generating electronic signature data by applying the secret signature key to the calculation result and the homomorphic ciphertext; and
transmitting the electronic signature data and the calculation result to the at least one external device.

11. The method as claimed in claim 7, further comprising:
acquiring an output value of a machine learning model by inputting the homomorphic ciphertext to the machine learning model trained to diagnose the password; and
transmitting the output value to the at least one external device.
